(19) United States
(12) Patent Application Publication
(10) Pub. No.: US 2026/0330573 A1
(43) Pub. Date: Oct. 22, 2026

(54) SYSTEMS AND METHODS FOR FORMING PROFESSIONAL ENGAGEMENTS

(71) Applicant: M. SHANE LUCADO, HOOVER, AL (US)

(72) Inventor: M. SHANE LUCADO, HOOVER, AL (US)

(21) Appl. No.: 19/186,099

(22) Filed: Apr. 22, 2025

(51) Int. Cl. G06Q 50/18; G06Q 10/1093

(52) U.S. Cl. CPC G06Q 50/18; G06Q 10/1093

(57) ABSTRACT

Methods of forming a professional engagement between a client and an attorney using a computer may include the step of presenting via a client interface an anonymous attorney profile chosen from a number of anonymous attorney profiles, and the step of presenting via an attorney interface an anonymous client profile corresponding to said client. The methods may include the step of accepting mutually a confirmatory attorney selection of the anonymous client profile and a confirmatory client selection of the anonymous attorney profile. The methods may include the step of opening by said computer a communication pathway between the client interface and the attorney interface during a meeting time selected by the client and confirmed by the attorney, and the step of confirming via the client interface and the attorney interface a professional engagement between the client and the attorney. Related systems and compositions of matter are disclosed.

### BACKGROUND OF THE INVENTION

### Field

The present inventions related to E-commerce and, more particularly to improved Internet based systems and related methods for forming a professional engagement between an attorney and a client.

### Background

Sophisticated Internet based platforms such as those offered by Amazon, Walmart, eBay, Alibaba Group comprise a vast economically important marketplace where myriad products, generally tangible goods, are routinely bought and sold. Such platforms allow for sources of specific goods to be easily located and for subsequent ease of purchase of the goods. Goods may range from consumer items to industrial and commercial products, and the goods may be purchased in almost any quantity with delivery within a few days at most. In product purchases using such platforms, the platform controls the transaction so that all interactions between the purchaser and the seller occur through the platform. There is usually no seller-purchaser contact outside the platform. Confining the transaction to the platform allows for the platform owner (e.g., Amazon, Walmart, etc.) to receive some payment for enabling and, perhaps, fulfilling the transaction, and, thus, compensates the platform owner for providing the platform and incentivizing improving the platform.

In contrast to the sale of goods, the Internet based marketplace may not function so efficiently in obtaining professional services. A high percentage of professional service consumers may have an effective inability or substantial high degree of difficulty connecting/securing a professional service provider. (See for example The Justice Gap: The Unmet Civil Legal Needs of Low-income Americans, Legal Services Corporation, April 2022; State of U.S. Small Law Firms, American Bar Association and Thomson Reuters Institute, Nov. 21, 2023) Factors that may contribute to this systemic market inefficiency may include: i) remarkable and ever-evolving specialization of professional service; ii) lack of reliable and accurate data readily available for professional service providers; iii) lack of standardized objective and measurable data for professional service providers; iv) relative sophistication of the professional service consumer; and v) lack of effective and efficient systems and methods for necessary inclusive steps of professional service engagement: identifying, connecting with, comparing, and securing the professional service provider.

For example, a client seeking an attorney faces a number of obstacles in first identifying and then hiring a suitable attorney. The client may find information about various attorneys online using legal platforms, for example, Martindale Hubbell, Avvo, that are essentially Internet based advertising systems. An Internet version of the highway billboard. While some filtering may be possible, for example, to isolate those practicing in a specialty practice area or geographic location, at some point the client must then research each attorney at least using information on the legal platform to ascertain whether the attorney is suitable for the client and the client's case. Upon finding a possibly suitable attorney, the client may then contact the attorney, exchange information, arrange an interview, obtain the consent of the attorney with respect to representation, and, perhaps finally, form a professional engagement between the attorney and client.

At least some of these activities such as, for example, the interview and exchange of information may be conducted outside the platform. Thus, as currently construed, legal platforms for clients seeking attorneys do not form attorney client engagements with the same efficiencies as Internet platforms directed toward the purchase of goods. Furthermore, attorney client interactions may not be confined to the legal platform but may require some attorney client interactions outside the legal platform in order to consummate an attorney client engagement, which may result in lack of compensation to the legal platform owner resulting in lack of improvements to the platform.

Accordingly, there is a need for improved Internet based systems as well as related methods and compositions of matter that facilitate formation of attorney client engagements starting with a client seeking an attorney.

### BRIEF SUMMARY OF THE INVENTION

These and other needs and disadvantages may be overcome by the methods and related systems and compositions of matter disclosed herein. Additional improvements and advantages may be recognized by those of ordinary skill in the art upon study of the present disclosure.

In various aspects, methods of forming a professional engagement between a client and an attorney using a computer disclosed herein include the step of presenting via a client interface an anonymous attorney profile chosen from a number of anonymous attorney profiles of an attorney database and corresponding to said attorney for viewing by said client, and the step of presenting via an attorney interface an anonymous client profile corresponding to said client for viewing by said attorney. The methods include the step of accepting mutually a confirmatory attorney selection of the anonymous client profile and a confirmatory client selection of the anonymous attorney profile, in various aspects. The methods include the step of presenting by the attorney interface one or more proposed meeting times chosen by a client action received via the client interface, and the step of selecting via the attorney interface a meeting time from the one or more proposed meeting times, in various aspects. The methods include the step of opening by said computer a communication pathway between the client interface and the attorney interface during the meeting time thereby allowing communications between the client and the attorney, in various aspects. The methods include the step of confirming via the client interface and the attorney interface a professional engagement between said client and said attorney, in various aspects. In various aspects, the methods include the step of receiving client information via the client interface wherein the client information comprises client identifying information and case information.

In various aspects, a professional engagement system disclosed herein includes a client interface configured to communicate with a client and an attorney interface configured to communicate with a selected attorney. A cloud including cloud resources is in operable communication with the client interface and with the attorney interface with the cloud being configured to form a professional engagement between the client and the selected attorney, in various aspects. In various aspects, said professional engagement system is closed to control completely formation of the professional engagement between the client and the selected attorney solely by communications with the client interface and with the attorney interface. In various aspects, the client interface is configured to receive client information including client identifying information and case information, client selection, proposed meeting times, client communication, and client engagement confirmation, from the client and to communicate anonymous attorney profiles, meeting time, attorney communication, and attorney engagement confirmation to the client. In various aspects, the attorney interface is configured to receive an attorney selection, a meeting time selected from several proposed meeting times, an attorney communication, and an attorney engagement confirmation from the selected attorney and to communicate anonymous client information, proposed meeting times, client communication, and client engagement confirmation. In various aspects, said professional engagement system includes an attorney profile database comprising one or more anonymous attorney profiles in operable communication with the cloud to match one or more anonymous attorney profiles of the attorney profile database to client information received via the client interface. In various aspects, said professional engagement system includes an Al component configured to cooperate with the client interface to receive client information including client identifying information and case information.

Non-transitory computer readable media is disclosed herein. In various aspects, the non-transitory computer readable media includes computer readable instructions that, upon execution, cause a computer to function as at least portions of the professional engagement system or to implement at least some of the method steps of the methods of forming a professional engagement.

This brief summary of the invention is presented to provide a basic understanding of some aspects of the methods and related systems and compositions of matter disclosed herein as a prelude to the detailed description that follows below. Accordingly, this brief summary of the invention is not intended to identify key elements of the methods and related systems and compositions of matter disclosed herein or to delineate the scope thereof.

### BRIEF DESCRIPTION OF THE DRAWINGS

FIG. 1 illustrates by schematic diagram an exemplary implementation of a professional engagement system according to aspects of the present inventions;

FIG. 2A illustrates by schematic diagram an operational condition of the exemplary professional engagement system of FIG. 1;

FIG. 2B illustrates by schematic diagram a second operational condition of the exemplary professional engagement system of FIG. 1;

FIG. 2C illustrates by schematic diagram a third operational condition of the exemplary professional engagement system of FIG. 1;

FIG. 2D illustrates by schematic diagram a fourth operational condition of the exemplary professional engagement system of FIG. 1;

FIG. 2E illustrates by schematic diagram a fifth operational condition of the exemplary professional engagement system of FIG. 1;

FIG. 2F illustrates by schematic diagram a sixth operational condition of the exemplary professional engagement system of FIG. 1;

FIG. 2G illustrates by schematic diagram a seventh operational condition of the exemplary professional engagement system of FIG. 1;

FIG. 2H illustrates by schematic diagram an eighth operational condition of the exemplary professional engagement system of FIG. 1;

FIG. 2I illustrates by schematic diagram a ninth operational condition of the exemplary professional engagement system of FIG. 1;

FIG. 2J illustrates by schematic diagram a tenth operational condition of the exemplary professional engagement system of FIG. 1;

FIG. 3 illustrates by schematic diagram portions of the exemplary professional engagement system of FIG. 1;

FIG. 4 illustrates by process flow chart exemplary operations of an exemplary professional engagement system; and,

FIG. 5 illustrates by process flow chart exemplary operations of an exemplary professional engagement system.

The Figures are exemplary only, and the implementations illustrated therein are selected to facilitate explanation. The Figures including the apparatus, methods, and compositions of matter illustrated in the Figures are not to be considered limiting unless expressly so stated. For example, the components of various apparatus illustrated in the Figures may be selected for explanatory purposes, and the components may be grouped in the Figures in various ways to facilitate description, so that the apparatus may include various other components or the components may be grouped in various other ways, in other implementations. The steps in the various methods illustrated in the Figures, for example, may be performed in other orders, or the steps in the various methods may be divided or subdivided in various ways, in other implementations. Methods, in other implementations, may include steps additional to those illustrated or may not include certain steps of the illustrated methods. Information flows and process flows in the Figures included herein are indicated by arrows, and are selected for explanatory purposes. It should be understood that other information flows may occur between various components and that other process flows may occur, in various other implementations. The number, position, relationship and dimensions of the elements shown in the Figures to form the various implementations described herein are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the Figures and are utilized to facilitate description thereof. Use herein of relative terms such as generally, about, approximately, essentially, may be indicative of engineering, manufacturing, computational, or scientific tolerances such as ±0.1%, ±1%, ±2.5%, ±5%, or other such tolerances, as would be recognized by those of ordinary skill in the art upon study of this disclosure.

### DETAILED DESCRIPTION OF THE INVENTION

Internet based professional engagement systems and related methods for forming a professional engagement between a client and an attorney are disclosed herein. In various aspects, the professional engagement system includes a client interface configured to communicate with a client and an attorney interface configured to communicate with a selected attorney. The professional engagement system forms a professional engagement between the client and the selected attorney solely by communications with the client interface and with the attorney interface, in various aspects. Accordingly, in such aspects, the professional engagement system is closed. That is, the professional engagement system controls completely the formation of the professional engagement between the client and the attorney with no attorney-client interaction occurring outside of or apart from the professional engagement system, in such aspects. The professional engagement system is hosted in the cloud using cloud based resources with the cloud in operable communication with the client interface and with the attorney interface, in various aspects.

As used herein, client, for example, may refer to a natural person, several natural persons (e.g., joint representation), or a juridical entity such as a corporation. Attorney, for example, may refer to a single attorney or to a group of attorneys such as a law firm. Professional engagement, for example, may refer to a contract between the attorney and the client under which the attorney represents the client.

The related methods for forming a professional engagement include the step of presenting via the client interface an anonymous attorney profile chosen from a number of anonymous attorney profiles of an attorney database and corresponding to the attorney for viewing by the client and presenting via an attorney interface an anonymous client profile corresponding to the client for viewing by said attorney, in various aspects. The related methods for forming a professional engagement include the step of accepting mutually a confirmatory attorney selection of the anonymous client profile by the attorney and a confirmatory client selection of the anonymous attorney profile by the client, in various aspects. The related methods for forming a professional engagement include selecting and confirming a meeting time, communicating via the client interface and the attorney interface during the meeting time, and confirming via the client interface and the attorney interface a professional engagement between said client and said attorney.

In various aspects, the professional engagement system may mitigate professional service market inefficiencies for both the client and attorney through use of a closed system requiring only a minimal data input and output for each user in order for the client to compare and secure the professional services of the attorney.

In various aspects, the professional engagement system collects standardized, objective, and measurable data of the professional service provider including specialization experience using time, volume, and recency metrics. The closed system may report this data directly to the client in addition to specific unit and project based service pricing data thereby allowing objective comparison of each attorney.

In various aspects, the professional engagement system collects standardized, objective and measurable data of the client including the client's legal issue, status, need, and economic factors related to the attorney's ability to be compensated for services. The closed system reports this data directly to the attorney provider allowing the provider to directly connect with the consumer through an intermediate communication interface allowing voice, video or in person communication, in various aspects.

A computer may be configured to implement at least a portion of the methods and related systems disclosed herein. Compositions of matter are disclosed herein in the form of non-transitory computer readable media comprising computer readable instructions that, when executed, cause one or more computers to function as at least portions of the systems or to implement at least some of the method steps of the methods.

Software including computer readable instructions, as used herein, may be, for example, in the form of high-level code such as C or Java, or may be in the form of machine code. In some aspects, software may execute on one computer. In other aspects, two or more computers may communicate with one another via network, and the software may be organized in various ways such that portions of the software may be distributed operatively over the two or more computers to be executed by the two or more computers. Although generally described as implemented by software, the methods disclosed herein may be implemented in hardware or in a combination of hardware and software, in various aspects. As may be recognized by those of ordinary skill in the art upon study of this disclosure, the methods, systems, and compositions of matter disclosed herein may be practiced in distributed computing environments where certain tasks are performed by processors, data storage, and other resources distributed in the cloud. A nominal representation of data may either be the data itself or a pointer, description, or other data that may be used to create the data.

As used herein, a processor is an electronic circuit that performs operations on data such as, for example, arithmetical operations, logical operations, and input/output (I/O) operations. A computer, as used herein, includes a one or more processors, and may, in various aspects, include memory, display, microphone, speaker, mouse, keyboard, storage device(s), I/O devices, network interface, and so forth. Computer may include, for example, single-processor or multiprocessor computers, minicomputers, mainframe computers, as well as personal computers, hand-held computing devices, mobile devices, cellular telephones, tablets, watches, and other processor-based devices, as may be readily recognized by those of ordinary skill in the art upon study of this disclosure. Computer may include one or more processors or processes distributed in a network cloud, in various aspects.

Cloud, network cloud, or network, as used herein, includes, for example, the Internet, local area networks (LAN), cell phone networks (e.g., 4G, 5G), text messaging networks (such as MMS or SMS networks), wide area networks (WAN), and combinations thereof. Data may be communicated through the network cloud by various wired and wireless technologies and combinations of wired and wireless technologies. The network cloud may include various cloud recourses, for example, processors, data storage devices, input/output devices, computers, servers, routers, amplifiers, wireless transmitters, wireless receivers, optical devices, virtualized resources, and other cloud based resources, as may be readily recognized by those of ordinary skill in the art upon study of this disclosure.

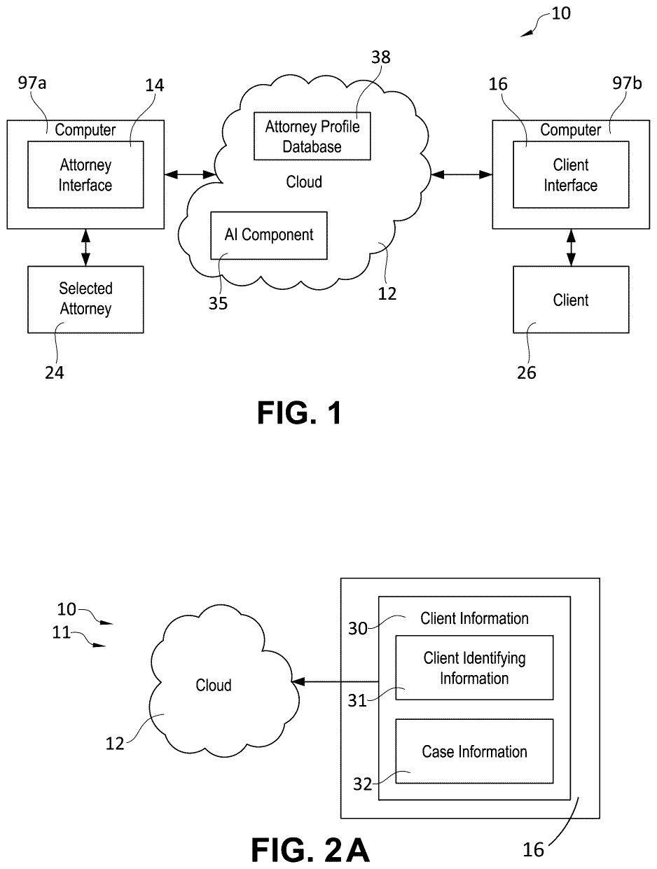

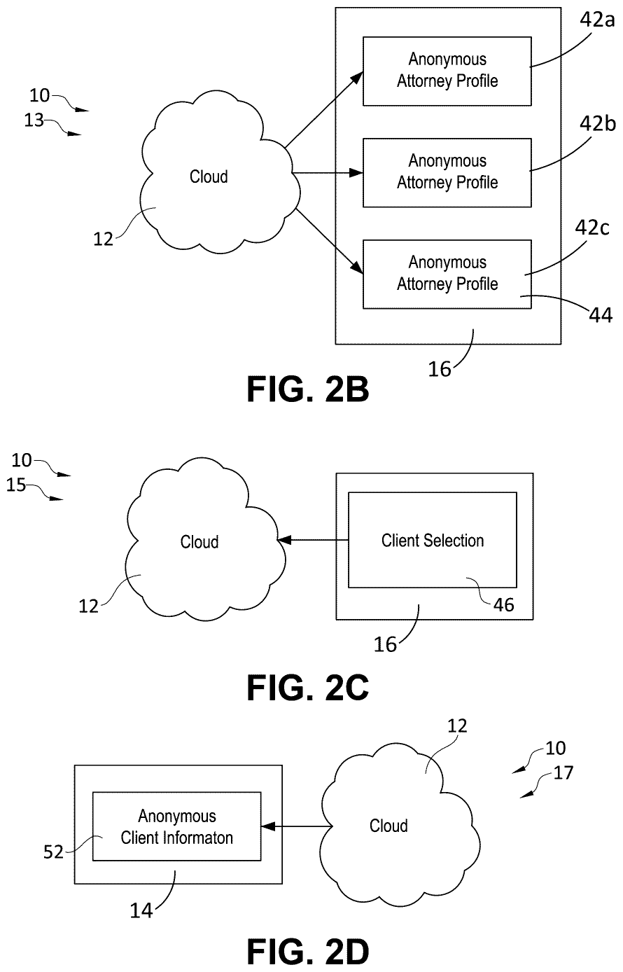

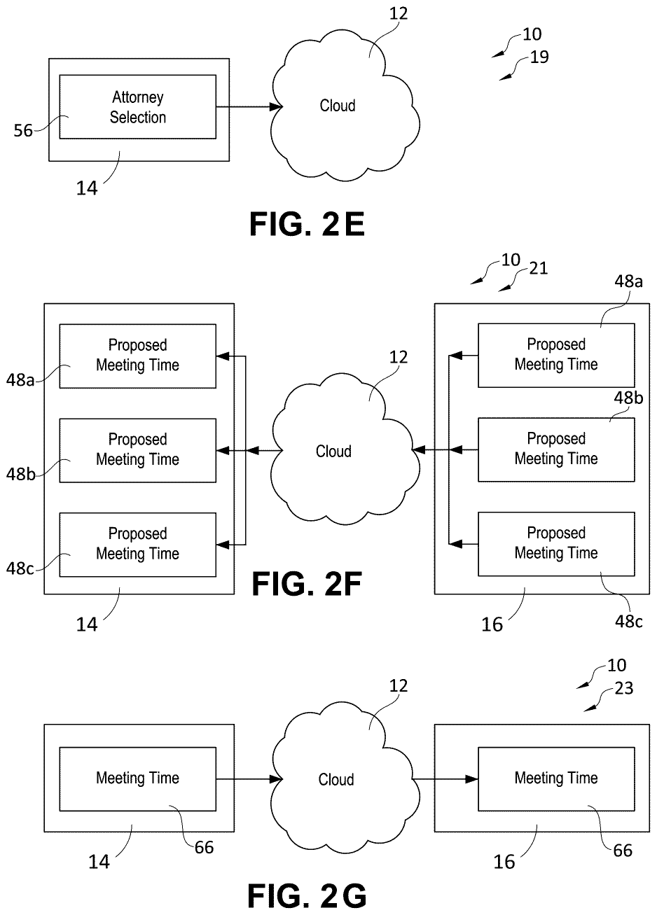

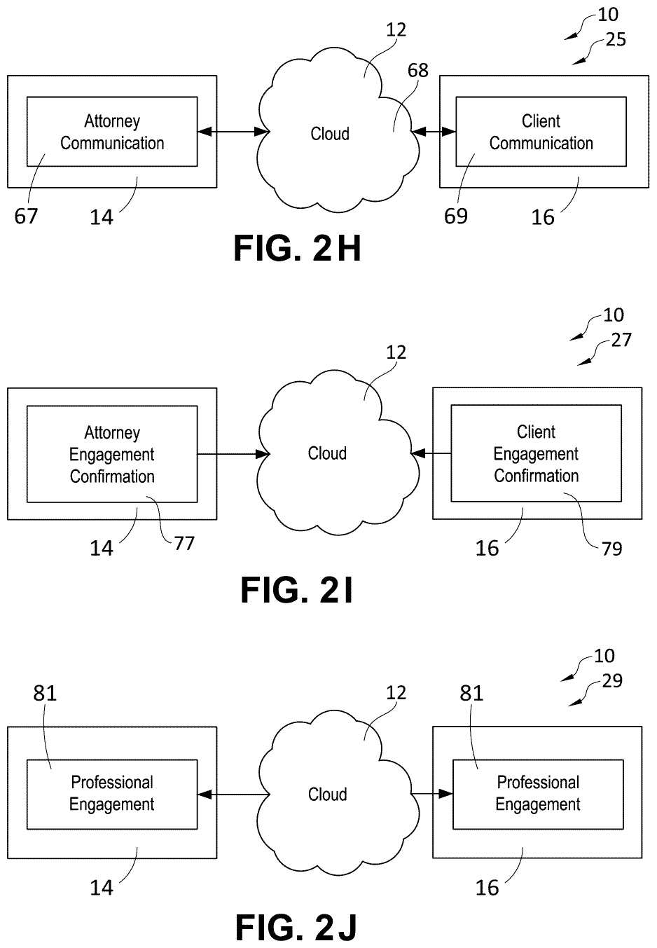

FIG. 1 illustrates exemplary professional engagement system 10. As illustrated in FIG. 1, professional engagement system 10 is implemented, at least in part, in cloud 12 including various cloud resources with cloud 12 moderating interactions between client interface 16 and attorney interface 14 and otherwise hosting professional engagement system 10 using the cloud based resources. Attorney interface 14 and client interface 16 are implemented using computers 97a, 97b, respectively, in communication with cloud 12, as illustrated. For example, attorney interface 14 and client interface 16 may be implemented as apps received by computers 97a, 97b configured as smart phones, respectively. Client 26 interacts with professional engagement system 10 via client interface 16, and selected attorney 24 interacts with professional engagement system 10 via attorney interface 14, in this implementation. Attorney interface 14 and client interface 16 are configured as human-computer interfaces configured to interact with selected attorney 24 and client 26 to communicate information with selected attorney 24 and client 26, respectively, in this implementation. Thus, in exemplary professional engagement system 10, client interface 16 is configured to receive client information 30 including client identifying information 31 and case information 32, client selection 46, proposed meeting times 48a, 48b, 48c, client communication 69, and client engagement confirmation 79 from client 26, and client interface 16 is configured to communicate anonymous attorney profiles 42a, 42b, 42c, meeting time 66, attorney communication 67, and attorney engagement confirmation 77 to client 16 (see FIGS. 2A, 2B, 2C, 2D, 2E, 2F, 2G, 2H, 21, 2J). Anonymous attorney profiles 42a, 42b, 42c are chosen from attorney profile database 38 using client information 30 with attorney profile database 38 hosted as a cloud resource of cloud 12, as illustrated. Similarly, in exemplary professional engagement system 10, attorney interface 14 is configured to communicate anonymous client information 52, proposed meeting times 48a, 48b, 48c, client communication 69, and client engagement confirmation 79 to selected attorney 24, and to receive attorney selection 56, meeting time 66, attorney communication 67, attorney engagement confirmation 77 from selected attorney 26. Attorney interface 14 and client interface 16 may communicate with one another during meeting time 66 via communication channel 68 to allow client 26 and selected attorney 24 to communicate with one another (see FIG. 2H). Professional engagement 81 is communicated via both attorney interface 14 and client interface 16 (see FIG. 2J). Attorney interface 14 and client interface 16 may, thus, include, for example, graphical user interfaces (GUI) including multi-modal interfaces, voice user interfaces (VUI), video, audio, along with the enabling hardware such as video display, speaker, microphone, keyboard, mouse, plus software at least a portion of which may be hosted in cloud 12.

FIGS. 2A, 2B, 2C, 2D, 2E, 2F, 2G, 2H, 21, 2J illustrate exemplary operational conditions 11, 13, 15, 17, 19, 21, 23, 25, 27, 29 respectively, of exemplary professional engagement system 10. Cloud 12 interacts with attorney interface 14 and with client interface 16 and attorney interface 14 and client interface 16 interact with one another as moderated by cloud 12, as illustrated. Interactions with cloud 12, client interface 16, and attorney interface 14 may be performed in a secure manner, for example, using encryption, virtual private networking, secure storage, multi-factor authentication, and so forth.

At operational condition 11, as illustrated in FIG. 2A, client information 30 is received by professional engagement system 10 via client interface 16. In this implementation, client information 30 includes client identifying information 31 indicative of an identity of client 26. Client identifying information 31 may include, for example, client name, client location (e.g., address), date of birth, and so forth. Client information 30 may include information re financial probity of client 26 such as a FICO score. As illustrated, client information 30 includes case information 32 descriptive of a legal case. For example, case information 32 may include the type of legal case (e.g., personal injury, bankruptcy, divorce, criminal defense, estate) and facts of the legal case, as may be useful to an attorney in evaluating the legal case.

At operational condition 13, as illustrated in FIG. 2B, professional engagement system 10 presents anonymous attorney profiles 42a, 42b, 42c via client interface 16. Each anonymous attorney profile 42a, 42b, 42c corresponds to attorney profile 41a, 41b, 41c, respectively, as illustrated. While three anonymous attorney profiles 42a, 42b, 42c are illustrated in FIG. 2B for explanatory purposes, it should be understood that any number of anonymous attorney profiles, such as anonymous attorney profile 42a, 42b, 42c, may be presented, and that client interface 16 may be refreshed to present additional attorney profiles or otherwise manipulated in various ways, as may be readily recognized by those of ordinary skill in the art upon study of this disclosure.

Anonymous attorney profiles 42a, 42b, 42c are chosen from an attorney profile database 38 using client information 30. For example, anonymous attorney profiles 42a, 42b, 42c may be chosen from attorney profile database 38 using client location as included in client identifying information 31 and case information 32. For example, price, practice area in relation to the case information 32, experience, volume of transactions, time in area, recency, geographic area in relation to the case information 32, conflicts, may be used in choosing anonymous attorney profiles 42a, 42b, 42c. Anonymous attorney profiles 42a, 42b, 42c corresponding to attorneys practicing in practice areas related to case information 32 may be chosen.

As an example, anonymous attorney profiles presented to a client located in Atlanta, GA with a criminal defense case are chosen from the attorney profile database 38 as corresponding to attorneys with the practice area of criminal defense and licensed in the State of Georgia. Initially, per this example, anonymous attorney profiles are chosen from the attorney profile database 38 as corresponding to attorneys practicing criminal defense primarily in the Atlanta area. Subsequently, anonymous attorney profiles may be chosen from the attorney profile database 38 as corresponding to attorneys practicing criminal defense primarily in Georgia but outside the Atlanta area and then attorneys practicing criminal defense primarily outside Georgia but licensed in the State of Georgia. The practice area of criminal defense may be further subdivided into DUI defense, federal criminal defense, etc. and corresponding anonymous attorney profiles presented according to case information 32. Thus, anonymous attorney profiles of DUI defense attorneys would be presented if case information 32 indicates a DUI case, anonymous attorney profiles of federal criminal defense attorneys would be presented if case information 32 indicates a federal criminal case, etc.

Anonymous attorney profiles 42a, 42b, 42c may be ranked according to performance using, for example, verdicts and settlements, transactions, representative clients, experience, honors and awards, special licenses and certifications, position within law firm, bar and other professional activity, pro bono and community service, scholarly lectures and writings, education and employment background, and other indicia of competence with each being accorded an objective score. Then, anonymous attorney profiles 42a, 42b, 42c may be presented according to the resultant objectively scored performance ranking.

Anonymous attorney profiles 42a, 42b, 42c presented using client interface 16 are anonymous so as to conceal identities of attorney profiles 41a, 41b, 41c and thus attorneys corresponding to anonymous attorney profiles 42a, 42b, 42c. Anonymous attorney profiles 42a, 42b, 42c may include various details re the corresponding attorneys such as years in practice, practice areas, skills, jurisdictions of practice, rating(s), and other information, as may be useful in evaluation by client 26.

At operational condition 15, as illustrated in FIG. 2C, client selection 46 is received via client interface 16. Client selection 46 selects selected anonymous attorney profile 44 of the presented anonymous attorney profiles 42a, 42b, 42c. In FIG. 2C, anonymous attorney profile 42c is illustrated as selected anonymous attorney profile 44 for explanatory purposes. Client selection 46 indicates that client 26 may be desirous of forming a professional engagement 81 with selected attorney 24 corresponding to anonymous attorney profile 42c, which is selected anonymous attorney profile 44. Client selection 46 may be negative meaning none of the presented anonymous attorney profiles 42a, 42b, 42c are selected. Such a negative client selection 46 may cause client interface 16 to present other anonymous attorney profiles in addition to and/or in substitution of anonymous attorney profiles 42a, 42b, 42c.

At operational condition 17, as illustrated in FIG. 2D, anonymous client information 52 is presented via attorney interface 14 to allow selected attorney 24 to assess forming professional engagement 81 with client 26. Anonymous client information 52 comprises at least portions of client information 30 including case information 34 in anonymized form that conceals the identity of client 26. Because client 26 interacts with anonymized attorney profiles, such as anonymized attorney profiles 42a, 42b, 42c, and because selected attorney 24 interacts with anonymized client information 52, selected attomey 24 and client 26 do not know each other's identity at operational condition 17, and, therefore, are precluded from interacting apart from professional engagement system 10.

At operational condition 19, as illustrated in FIG. 2E, attorney selection 56 is received via attorney interface 14. Attorney selection 56 indicates that selected attorney 24 is desirous of forming professional engagement 81 with client 26. Attorney selection 56 may be negative thereby indicating that selected attorney 24 is not desirous of forming a professional engagement, such as professional engagement 81, with client 26. Such a negative selection may be communicated via client interface 16 to client 26 and may cause displaying of other displayed attorney profiles, such as displayed attorney profiles 42a, 42b, 42c, to client 26.

Operational condition 21, which is illustrated in FIG. 2F, assumes a positive client selection 46 indicating that client 26 is desirous of forming professional engagement 81 with selected attorney 24 and a positive attorney selection 56 indicating that selected attorney 24 is desirous of forming professional engagement 81 with client 26. At operational condition 21, one or more proposed meeting times, such as proposed meeting times 48a, 48b, 48c, are chosen using client interface 16 and conveyed to attorney interface 14 for communication to selected attorney 24.

At operational condition 23, illustrated in FIG. 2G, meeting time 66 is then selected via the attorney interface 14 as one of proposed meeting times 48a, 48b, 48c. Meeting time 66 may be selected by selected attorney 24. Note that selected attorney 24 and client 26 do not know each other's identity at operational conditions, 19, 21, 23.

At operational condition 25, illustrated in FIG. 2H, communication pathway 68 is opened between attorney interface 14 and client interface 16. Attorney communications 67 are communicated to client interface 16 and client communications 69 are communicated to attorney interface 14 thereby allowing direct communications between client 26 and selected attorney 24 during meeting time 66, at operational condition 25. Prior to operational condition 25, both the client and attorneys are anonymous and attorney-client interactions are indirect and all moderated by professional engagement system 10 via cloud 12.

At operational condition 27, illustrated in FIG. 21, attorney engagement confirmation 77 confirming professional engagement 81 by selected attorney 81 with client 26 and client engagement confirmation 79 confirming professional engagement by client 26 with selected attorney 24 are exchanged.

At operational condition 29, illustrated in FIG. 2J, exchange of confirming attorney engagement confirmation 77 and client engagement thereby forms professional engagement 81. Professional engagement 81 is presented via both attorney interface 14 and client interface 16.

In certain implementations, professional engagement system 10 may include an artificial intelligence (AI) component 35 included as a cloud resource in cloud 12 to perform tasks such as learning, reasoning, problem-solving, perception, and decision-making. For example, AI component 35 may be configured to cooperate with client interface 16 to receive client information 30 including client identifying information 31 and case information 32. AI component 35 may be configured as a large language model (LLM) designed for natural language processing, for example. AI component may be trained against and adaptively improved using previous client information from previous clients. Examples of large language models that may be configured as at least a portion of AI component 35 include OpenAI's GPT-3 and GPT-4, Google's BERT and PaLM, and Meta's Llama models.

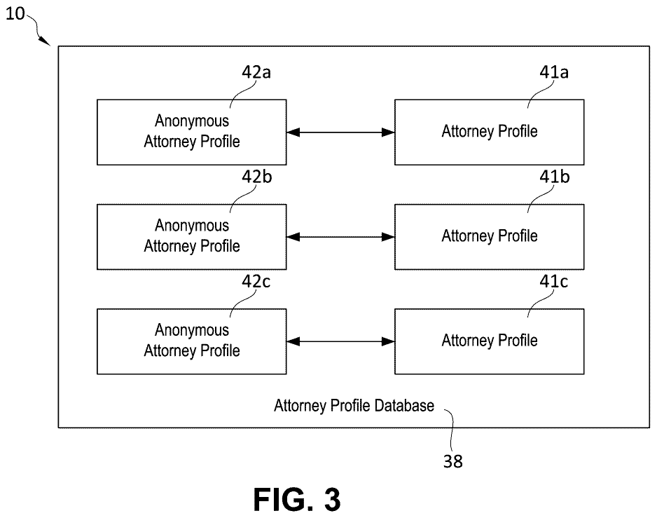

FIG. 3 illustrates attorney profile database 38 including anonymous attorney profiles 42a, 42b, 42c each having a corresponding attorney profile 41a, 41b, 41c, respectively. Each attorney profile, such as attorney profile 41a, 41b, 41c, corresponds to an attorney and includes information related to the attorney such as, for example, demographics, contact information, years in practice, practice area(s), skills, jurisdictions of practice, rating(s), license(s), and other information. Practice areas may include, for example without limitation, administrative law, alternative dispute resolution, antitrust litigation, appellate, banking, bankruptcy & creditor/debtor rights, bonds/government finance, business litigation, business/corporate, civil litigation defense, civil rights, class action/mass torts, closely held business, construction litigation, construction/surety, criminal defense, criminal defense for DUI/DWI, criminal defense for white collar crimes, criminal prosecution, elder law, employee benefits/ERISA, employment & labor, employment litigation defense, employment litigation representing plaintiffs, energy and natural resources, entertainment and sports, environmental, environmental litigation, estate planning and probate, family law, first amendment/media, franchise/dealership, general litigation, government/cities/municipalities, health care, immigration, information technology/outsourcing, insurance coverage, intellectual property, intellectual property litigation, international, land use/zoning, legal aid/legal services, mergers and acquisitions, non-profit, general personal injury defense, medical personal injury defense, products personal injury defense, general personal injury representing plaintiffs, medical personal injury representing plaintiffs, products personal injury representing plaintiffs, political law, professional liability defense, professional liability representing plaintiffs, real estate, schools and education, securities and corporate finance, securities litigation, tax, transportation/maritime, utilities, and workers' compensation. For example, case information 32 may correspond to any of these practice areas or combinations of practice areas.

Anonymous attorney profiles, such as anonymous attorney profiles 42a, 42b, 42c, may include at least a portion of the corresponding attorney profile anonymized to prevent identification of the corresponding attorney. While three anonymous attorney profiles 42a, 42b, 42c and corresponding attorney profiles 4la, 41b, 41c are illustrated for explanatory purposes, it should be understood that attorney profile database may include hundreds or thousands of attorney profiles and corresponding anonymous attorney profiles, in various implementations. Attorney profile database 38 may be structured as a relational database or in various other ways, as may be readily recognized by those of ordinary skill in the art upon study of this disclosure. Attorney profile database 38 may be queried including choosing of anonymous attorney profiles 42a, 42b, 42c for presentation via client interface 16 using, for example, structure query language (SQL). AI component 35 may be configured to cooperate with client information 30 and with attorney profile database 38 to select anonymous attorney profiles 42a, 42b, 42c for presentation via client interface 16. AI component 35 may be trained against and adaptively improved as anonymous attorney profiles are chosen using client information 30, presented, and accepted or rejected.

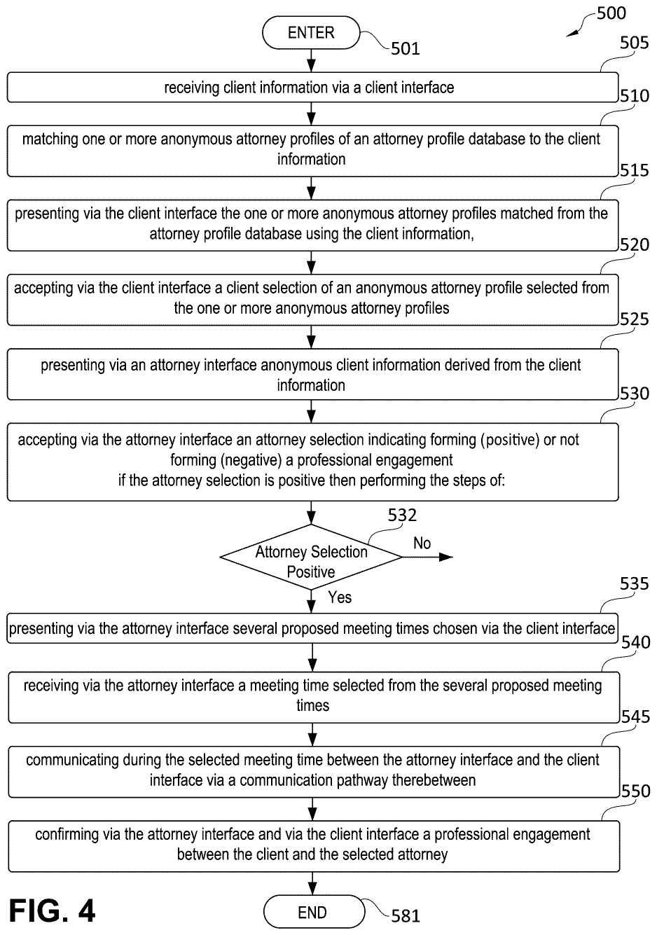

FIG. 4 illustrates exemplary operational method 500 of exemplary professional engagement system 10. Exemplary method 500 is entered at step 501.

At step 505, client information 30 is received via client interface 16. Client information 30 may be received via client interface 16 using GUI, VUI, and/or other data interfaces configured to interact with client 26. Client information 30 may be received, at least in part, via client interface 16 using AI component 35.

At step 510, one or more anonymous attorney profiles, such as anonymous attorney profiles 42a, 42b, 42c, of an attorney profile database 38 are matched to the client information 30. The one or more anonymous attorney profiles may be matched from attorney database 38 by being matched to the client information using AI component 35.

At step 515, the one or more anonymous attorney profiles matched from attorney database 38 using the client information 30 are presented via the client interface 16. Client 26 may then view the one or more attorney profiles in order to make an assessment thereof.

At step 520, a client selection 46 of a selected anonymous attorney profile 44 selected from the one or more anonymous attorney profiles is accepted via the client interface 16.

At step 525, anonymized client information 52 is presented via attorney interface 14.

At step 530, attorney selection 56 indicating forming (positive) or not forming (negative) a professional engagement is accepted via the attorney interface. If attorney selection 56 is negative, method 500 may present other anonymous attorney profiles via client interface 16.

At step 532, if attorney selection 56 at step 530 is positive, then branch to performing the steps of:

At step 535, several proposed meeting times chosen via the client interface 16 are presented via the attorney interface 14.

At step 540, a meeting time 66 selected from the several proposed meeting times is received via attorney interface 14 and may then be presented by client interface 16.

At step 545, a communication pathway 68 between client interface 16 and attorney interface 14 is opened during meeting time 66. Communication pathway 68 allows for interactive communication between selected attorney 24 and client 26 during meeting time 66.

At step 550 a professional engagement between client 26 and selected attorney 24 is confirmed via the attorney interface 14 and via the client interface 16. Exemplary method 500 ends at step 581.

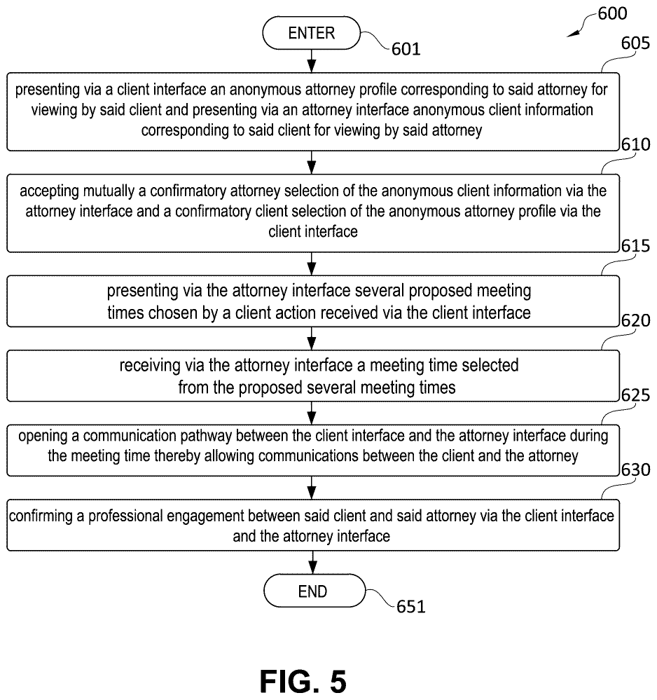

FIG. 5 illustrates another exemplary operational method 600. Exemplary method 600 is entered at step 601.

At step 605, an anonymous attorney profile is presented via a client interface for viewing by said client and an anonymous client profile is presented for viewing by said attorney via an attorney interface. The anonymous attorney profile corresponds to an attorney and the anonymous client profile corresponds to a client.

At step 610, a client selection of the anonymous attorney profile via the client interface and an attorney selection of the anonymous client profile via the attorney interface are mutually accepted. That is, the client selection indicates acceptance of the attorney and the attorney selection indicates acceptance of the client. The attorney and the client must both accept each other as indicated by the attorney selection and the client selection at step 610 in order to proceed to step 615.

At step 615, several proposed meeting times chosen via the client interface by the client are presented by the attorney interface for reception of an attorney action.

At step 620 a meeting time selected from the several proposed meeting times is received via the attorney interface.

At step 625 a communication pathway is opened between the client interface and the attorney interface during the meeting time allowing communication between the client interface and the attorney interface. The client and the attorney may communication with one another via the communication pathway.

At step 630, a professional engagement is confirmed between the client and the attorney via the client interface and the attorney interface. Various actions may be communicated between the client interface and the attorney interface in confirming the professional engagement. Method 600 ends at step 651.

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 37 C.F.R. § 1.72(b) only. Accordingly, the Abstract is not intended to identify key elements of the apparatus and methods disclosed herein or to delineate the scope thereof. Upon study of this disclosure and the exemplary implementations herein, one of ordinary skill in the art may readily recognize that various changes, modifications and variations can be made thereto without departing from the spirit and scope of the inventions as defined in the following claims.

The invention claimed is:

1. A method of forming a professional engagement between a client and an attorney using a computer, comprising the steps of:
presenting via a client interface an anonymous attorney profile chosen from a number of anonymous attorney profiles of an attorney database and corresponding to said attorney for viewing by said client and presenting via an attorney interface an anonymous client profile corresponding to said client for viewing by said attorney;
accepting mutually a confirmatory attorney selection of the anonymous client profile and a confirmatory client selection of the anonymous attorney profile;
presenting by the attorney interface one or more proposed meeting times chosen by a client action received via the client interface;
selecting via the attorney interface a meeting time from the one or more proposed meeting times;
opening by said computer a communication pathway between the client interface and the attorney interface during the meeting time thereby allowing communications between the client and the attorney; and
confirming via the client interface and the attorney interface a professional engagement between said client and said attorney.

2. The method of claim 1, further comprising the step of:
receiving client information via the client interface, the client information comprising client identifying information and case information.

3. The method of claim 2, where the anonymous client profile comprises at least a portion of the client information anonymized to conceal an identity of said client.

4. The method of claim 2, further comprising the step of:
choosing the anonymous attorney profile for presentation by matching one or more attorney profiles of an attorney profile database to the client information.

5. The method of claim 4, wherein the matching is performed using one or more criteria selected from a group consisting of price, practice area in relation to the case, experience, volume of transactions, time in area, recency, geographic area in relation to the case, conflicts.

6. The method of claim 1, further comprising the step of:
presenting successively anonymous attorney profiles via the client interface until selection of an anonymous attorney profile of the anonymous attorney profiles using the client interface.

7. The method of claim 1, further comprising:
triggering the presenting of the anonymous client profile by selecting of the attorney profile.

8. The method of claim 1, wherein the client interface is configured at least in part as a web portal.

9. The method of claim 1, wherein the communication pathway comprises at least in part a web portal.

10. A method of forming a professional engagement using a computer, comprising the steps of:
receiving client information via a client interface;
matching one or more anonymous attorney profiles of an attorney profile database to the client information;
presenting via the client interface the one or more anonymous attorney profiles;
accepting via the client interface a client selection of an anonymous attorney profile selected from the one or more anonymous attorney profiles;
presenting via an attorney interface anonymous client information derived from the client information;
accepting via the attorney interface an attorney selection indicating forming or not forming a professional engagement, if the attorney selection indicates forming said professional engagement then performing the steps of:
presenting via the attorney interface several proposed meeting times chosen via the client interface;
receiving via the attorney interface an attorney meeting time selection selecting a meeting time of the several proposed meeting times;
communicating during the meeting time between the attorney interface and the client interface via a communication pathway therebetween; and
confirming via the attorney interface and via the client interface said professional engagement between the client and the selected attorney.

11. The method of claim 10, further comprising the step of:
repeating the step of presenting via the client interface one or more anonymous attorney profiles chosen from an attorney database using the client information until the client selection of the anonymous attorney profile is accepted via the client interface.

12. The method of claim 10, further comprising:
triggering the presenting of the anonymous client profile by selecting of the attorney profile.

13. The method of claim 10, wherein the matching is performed using one or more criteria selected from a group consisting of price, practice area in relation to the case, experience, volume of transactions, time in area, recency, and geographic area in relation to the case.

14. The method of claim 10, wherein the client interface is configured as an app operably received by a smartphone.

15. A professional engagement system, comprising:
a client interface configured to communicate with a client;
an attorney interface configured to communicate with a selected attorney;
a cloud including cloud resources in operable communication with the client interface and with the attorney interface and configured to form a professional engagement between the client and the selected attorney; and
wherein said professional engagement system is closed to control completely formation of the professional engagement between the client and the selected attorney solely by communications with the client interface and with the attorney interface.

16. The system of claim 15, wherein the client interface is configured to receive client information including client identifying information and case information, client selection, proposed meeting times, client communication, and client engagement confirmation, from the client and to communicate anonymous attorney profiles, meeting time, attorney communication, and attorney engagement confirmation to the client.

17. The system of claim 15, wherein the attorney interface is configured to receive an attorney selection, a meeting time selected from several proposed meeting times, an attorney communication, and an attorney engagement confirmation from the selected attorney and to communicate anonymous client information, proposed meeting times, client communication, and client engagement confirmation.

18. The system of claim 15, further comprising:
an attorney profile database comprising one or more anonymous attorney profiles in operable communication with the cloud to match one or more anonymous attorney profiles of the attorney profile database to client information received via the client interface.

19. The system of claim 18, wherein the selected attorney is accepted by client selection via the client interface of an anonymous attorney profile of the one or more anonymous attorney profiles.

20. The system of claim 15, further comprising:
an AI component configured to cooperate with the client interface to receive client information including client identifying information and case information.
